(19) United States
(12) Patent Application Publication
(10) Pub. No.: US 2026/0182483 A1
(43) Pub. Date: Jul. 2, 2026

(54) SKID STEER DROP PLOW

(71) Applicant: CMP Attachments, LLC, Clear Lake, MN (US)

(72) Inventors: Derek William KENT, Becker, MN (US); David Thomas PHANEUF, JR., Saint Cloud, MN (US)

(73) Assignee: CMP Attachments, LLC, Clear Lake, MN (US)

(21) Appl. No.: 19/434,984

(22) Filed: Dec. 29, 2025

Related U.S. Application Data
(60) Provisional application No. 63/739,183, filed on Dec. 27, 2024.

(51) Int. Cl. A01B 63/108; A01B 3/38

(52) U.S. Cl. CPC A01B 63/108; A01B 3/38

(57) ABSTRACT

A skid steer drop plow system includes a support assembly connecting a vibratory drop plow to a skid steer loader. The vibratory drop plow includes a blade connected to a shaker weight assembly for forming a trench. The shaker assembly is connected to the skid steer by a support assembly that positions the shaker assembly and blade a distance from the cab of the skid loader to permit the door to open when the shaker assembly is in either a raised or lowered position. The support assembly has a pivoting frame assembly disposed between a pivot assembly and tilt knuckle assembly. The pivot assembly connects to the skid loader, and forms a pivot connection with the pivoting frame assembly, permitting lateral rotation of the blade with respect to the skid loader. The tilt assembly is connected to the drop plow includes an actuator for raising and lowering the blade.

### CROSS-REFERENCE TO RELATED APPLICATIONS

This application claims priority in U.S. patent application Ser. No. 63/739,183, filed Dec. 27, 2024, the contents of which are hereby incorporated by reference.

### BACKGROUND

### 1. Field of the Disclosed Subject Matter

The disclosed subject matter relates generally to soil-shifting machines, and more particularly to a reciprocating digging element and its attachment to the soil-shifting machine.

### 2. Background

Self-propelled machines, such as tractors or skid steer loaders are used to work soil. A skid steer loader is a wheeled or tracked vehicle that includes a pair of arms that pivot on a frame. Tools are attached to the arms, and an operator manipulates the tool by moving the arms and actuating an actuator, such as a hydraulic or electro-mechanical components to position and manipulate the tool. Tools, such as plows, aid an operator in working the soil.

A plow may be pulled through the soil to bury material in the soil. A plow in the form of an elongated blade may be attached to skid steer arms, and the blade plunged into the ground to form a narrow trench in the ground. A rapid, oscillatory motion may be transmitted to the blade, such as by a vibrating motor, to aid in pulling the plow blade through the soil. A cable, conduit, pipe, or other hardware can be attached by a lug or other connector to the plow blade to install such material underground at a desired depth and along a desired path, without the time, expense, and disruption of digging a traditional wide trench.

Until now there has not been available a plow system for use with a skid steer vehicle with the advantages and features of the disclosed subject matter.

### SUMMARY

A support and articulation assembly provides a connection between a vehicle, such as a skid steer loader, and a vibratory drop plow system, for forming trenches in soil.

In an embodiment, the support and articulation assembly includes a pivot assembly connected to the vehicle, a pivoting frame assembly pivotally connected to the pivot assembly, a tilt knuckle assembly pivotally connected to the pivoting frame assembly, and a plow blade connected to the tilt knuckle assembly for forming the trench.

In some embodiments, the support and articulation assembly includes a pivot assembly with a vehicle engaging portion and a first pivot connection, a pivoting frame assembly that interfaces with the pivot assembly, a tilt knuckle assembly pivotally connected to the pivoting frame assembly, and a plow blade operably connected to the tilt knuckle assembly. An actuator extending between the pivoting frame assembly and tilt knuckle assembly pivots the tilt knuckle assembly forward and rearward relative to the pivoting frame assembly.

In some aspects, the support and articulation assembly includes a pivot assembly with a vehicle engaging portion, and a first pivot connection formed by an upper and lower sleeve. A pivoting frame assembly forms a second pivot connection formed by a tube received between the upper and lower sleeves, with the pivoting frame assembly rotatable about a pin extending through the sleeves and tube. A generally Y-shaped tilt knuckle assembly is pivotally connected to the pivoting frame assembly, and forms an upper and lower arm for attaching a shaker assembly attached to a plow blade for forming a trench in the soil.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

The present disclosed subject matter is described herein with reference to the following drawing figures by way of example and are not limited by the accompanying figures for which like references indicate like elements, and with greater emphasis being placed on clarity rather than scale:

FIG. 1 is an isometric view of a plow system in a lowered position attached to a skid steer loader embodying principles of the disclosed subject matter.

FIG. 2 is a side elevation view of FIG. 1.

FIG. 3 is a side elevation view of the plow system in a raised position.

FIG. 4 is an isometric view from above of the plow system.

FIG. 5 is an exploded view of FIG. 4.

FIG. 6 is an isometric view from below of the plow system.

FIG. 7 is an isometric view from above of the plow system.

FIG. 8 is a plan view of the plow system.

FIG. 9 is a side elevation view of the plow system.

FIG. 10 is a bottom view of the plow system.

FIG. 11 is an isometric view of the shaker assembly with the gear housing partially removed.

FIG. 12 is a front elevation view of the shaker assembly with the front cover removed.

FIG. 13 is a cross-sectional view of the shaker assembly taken along the line13-13 in FIG. 12.

FIG. 14 is a cross-sectional view of the shaker assembly taken along the line14-14 in FIG. 13.

FIG. 15 is an elevation view of an aspect of the plow system embodying principles of the disclosed subject matter.

FIG. 16 is a schematic diagram of the hydraulic system.

### DETAILED DESCRIPTION

Certain terminology will be used in the following description for convenience in reference only and will not be limiting. For example, up, down, top, bottom, front, back, rear, right, left, forward, rearward, upward, and downward refer to the disclosed subject matter as orientated in the view being referred to, or in reference to such terminology designating the characteristics of an assembly as described in this description. Such terminology will include the words specifically mentioned, derivatives thereof, and words of similar meaning.

Referring to the drawings, a tool such as a drop plow system 100 embodying principles of the disclosed subject matter includes a support and articulation assembly between a motorized vehicle, such as a skid steer loader 102, and a shaker assembly 310 used to shake or vibrate a drop plow blade 328 as it is drawn through the ground 116 to form a trench 112 below the surface 114 for the burying of material, such as cabling or conduit. The support and articulation assembly generally includes a pivot assembly 130 connected to a pivoting frame assembly 150 connected to a tilt knuckle assembly 210, with the support and articulation assembly creating a distance between the motorized vehicle and the drop plow blade 328. The pivot assembly 130 formed by an attachment assembly 120 is operably connected to the skid steer loader 102. The pivoting frame assembly 150 is disposed between the pivot assembly 130 and a tilt knuckle assembly 210, allowing the pivoting frame assembly 150 to rotate laterally approximately 20 degrees on either side of a line perpendicular to the front face 124 of the attachment mechanism 120. The tilt knuckle assembly 210 is disposed between the pivoting frame assembly 150 and shaker assembly 310 and pivots forward and rearward relative to the pivoting frame assembly 150, allowing positioning of the angle of a leading edge 333 of the blade 328 within the ground 116, and the depth of the blade 328 within the ground 116.

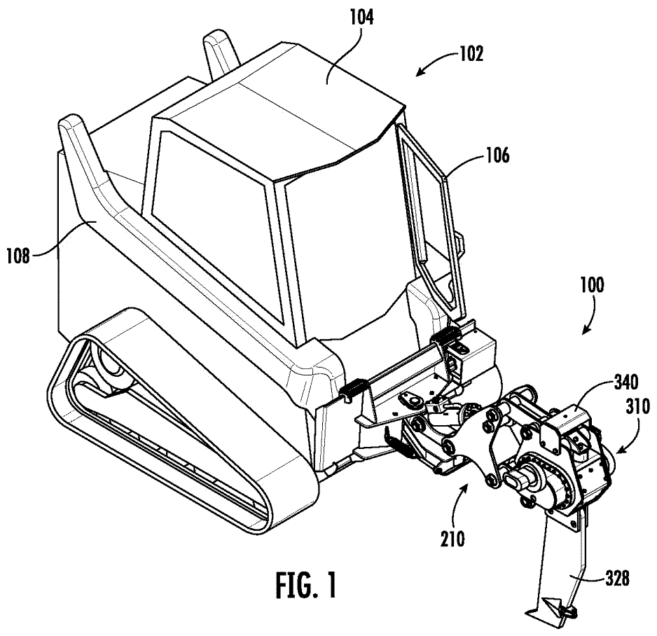

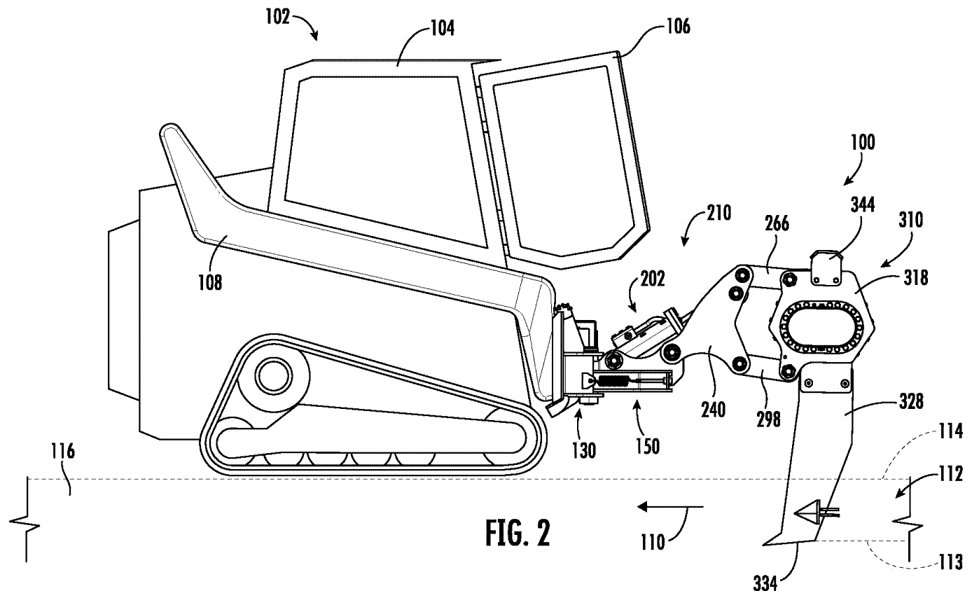

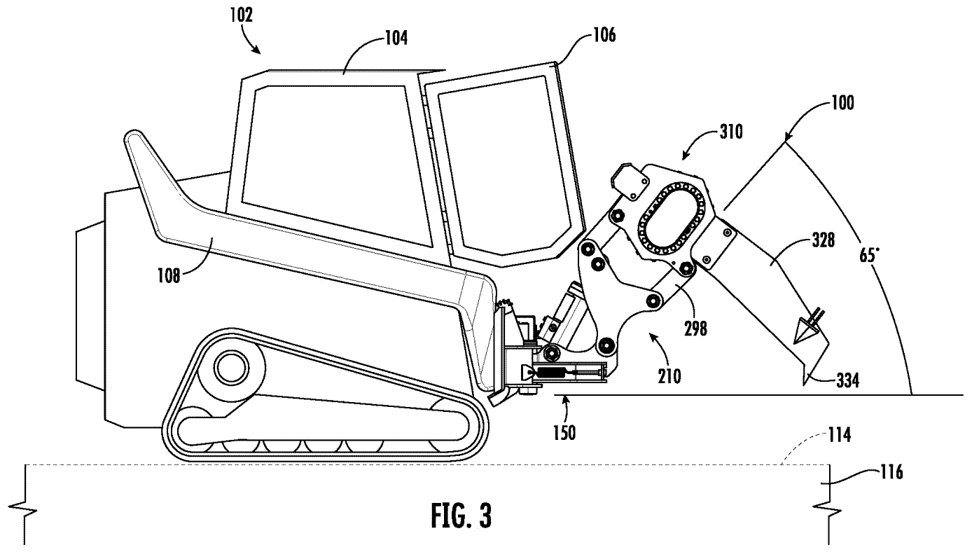

Referring to FIGS. 1-3, the drop plow system 100 is shown connected to the arms 108 of a skid steer loader 102 in front of an operator cab 104 having a forward-opening door 106. The arms 108 are raised and lowered by an actuator. The attachment mechanism 120 facilitates attachment of the drop plow system 100 to a coupler at the ends of the arms 108 at the front of the skid steer loader 102. The attachment mechanism 120 and pivoting frame assembly 150 position the tilt knuckle assembly 210 and shaker assembly 310 a distance from the cab 104, allowing the arms of the skid steer loader 102 to remain in the lowered position when the drop plow system 100 is in use, and allows an operator to open the door 106 outward toward the drop plow system 100 to enter and exit the cab 104 when the blade 328 is in use below the surface 114 of the ground 116 (FIG. 2), and when the blade 328 is not in use above the ground 116 (FIG. 3) such as when the skid steer loader 102 is moving the drop plow system 100 to a work location.

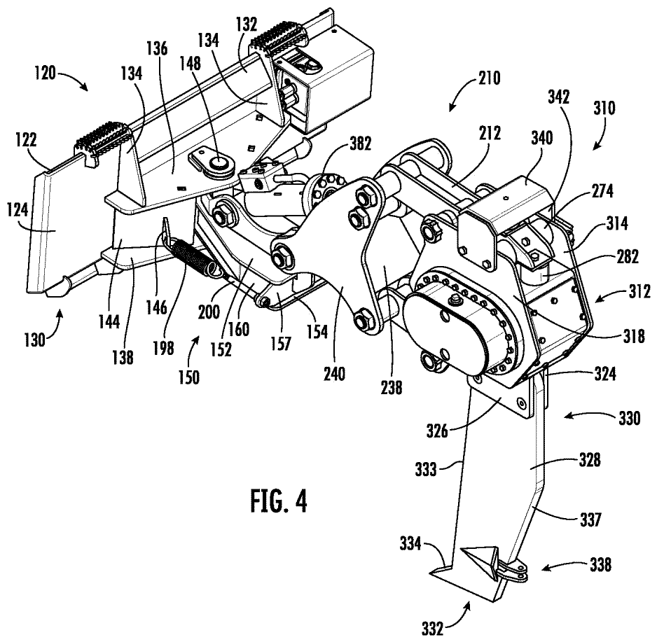

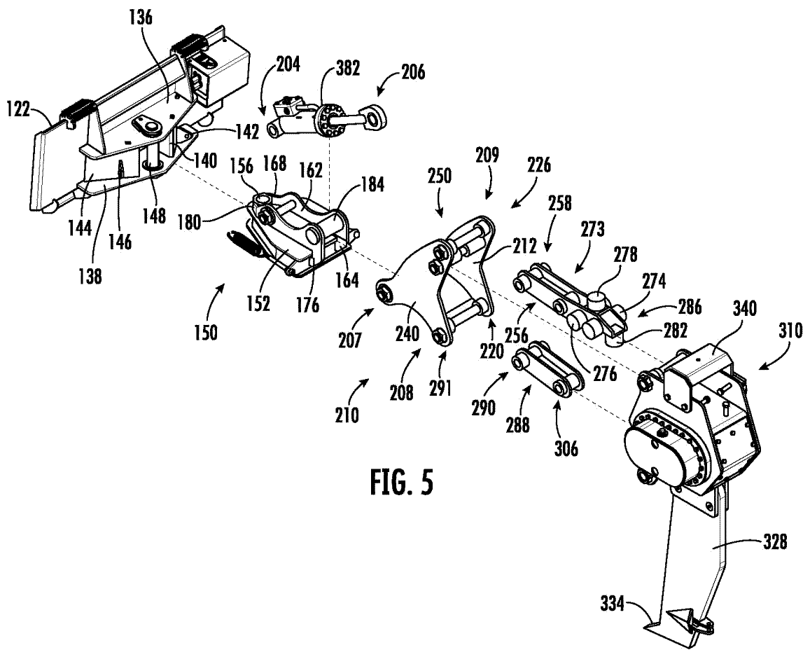

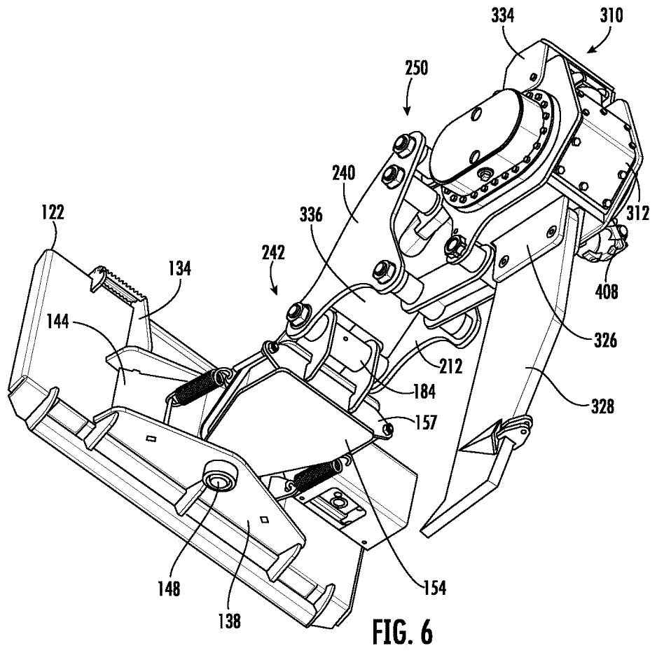

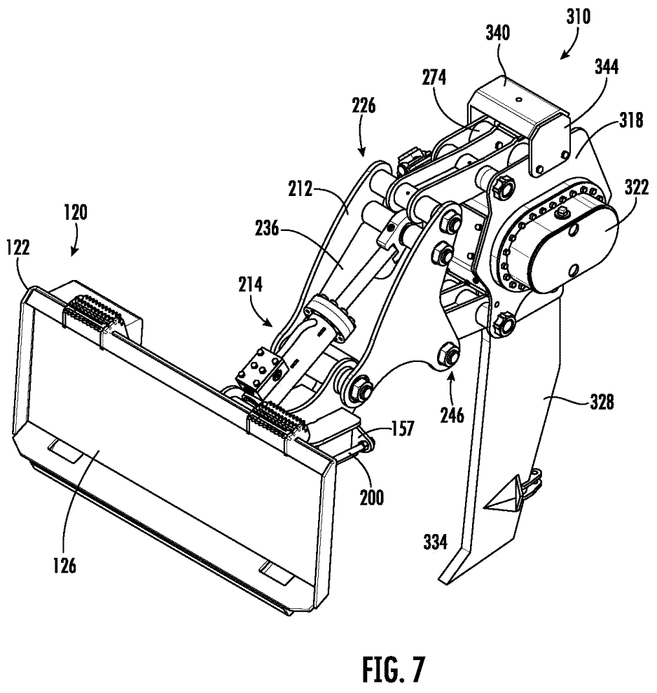

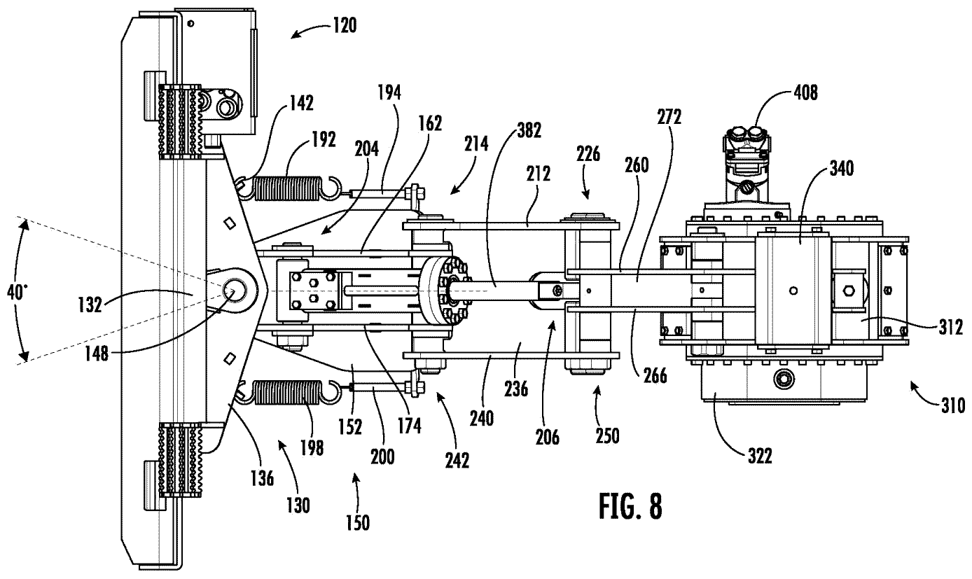

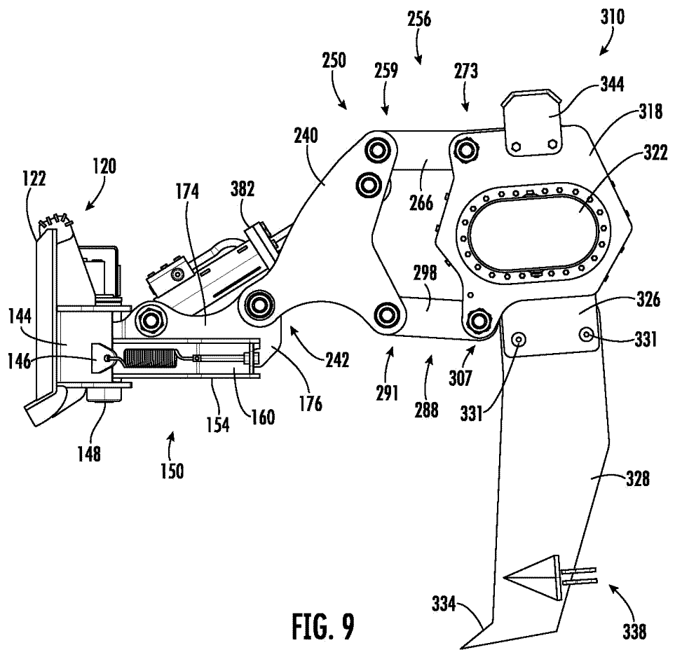

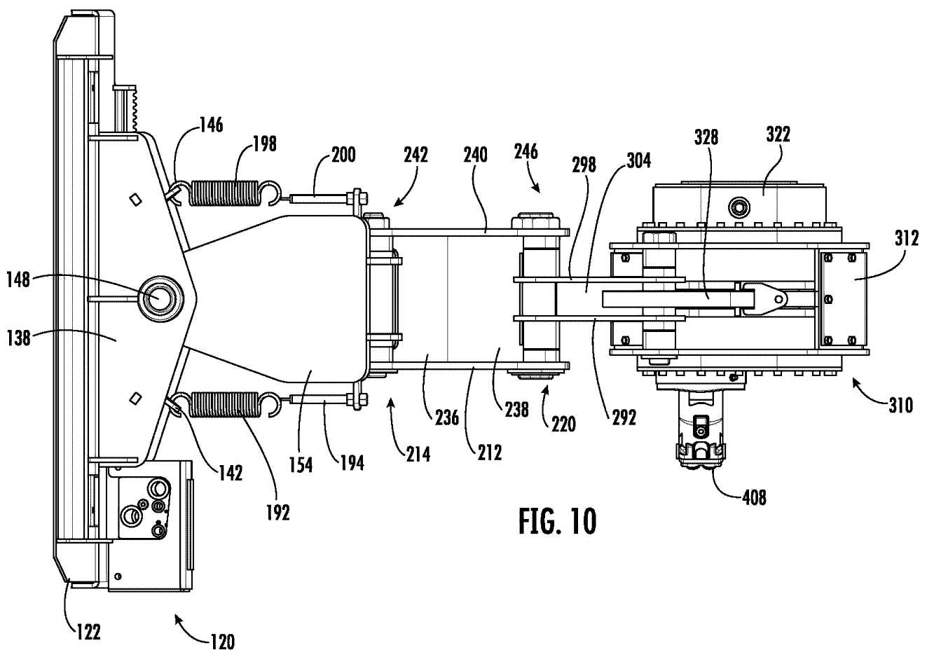

Referring to FIGS. 4-10, the attachment mechanism 120 includes a mounting plate 122 adapted for connecting the attachment mechanism 120 to the skid steer loader 102. In an implementation, the mounting plate 122 forms a recess for connecting the drop plow system 100 to a cooperating coupler attached to the arms 108. The mounting plate 122 can be metal, and forms a front face 124 and a rear face 126. In an implementation, the rear face 126 of the mounting plate 122 is adapted to connect to a coupler of the skid-steer loader 102 at the forward ends of the arms 108, such as by forming a receiving cavity proximate an upper end of the mounting plate 122. Various mounting plates, skid-steer loaders and their associated couplers and mechanical features and functions are commonly known in the art.

The pivot assembly 130 is at the front face 124 of the mounting plate 122 and the pivoting frame assembly 150 is pivotally attached to the pivot assembly 130 by first and second interfacing pivot connections, here utilizing a pin 148. The pivot assembly 130 first cooperating pivot connection has an upper pivot plate 136 with an upper sleeve adjacent a front edge and a lower pivot plate 138 with a lower sleeve adjacent a front edge. The spaced upper and lower sleeves form apertures aligned along a pivot centerline for receiving the pivot pin 148. A first side plate 140 extending between the upper and lower pivot plates 136, 138 extends forward from the left side of the front face 124 toward the upper and lower sleeves, and a second side plate 144 extending between the upper and lower pivot plates 136, 138 extends forward from the right side of the front face 124 toward the upper and lower sleeves. The first and second side plates 140, 144 add structural support to the pivot assembly 130 and provide structure for attaching mounts 142, 146. A backer 132 attached to the front face 124 above the upper pivot plate 136 extends between upper gussets 134 providing additional structural support to the attachment mechanism 120 and upper pivot plate 136. The above components of the pivot assembly 130 are manufactured from metal and may be welded to the front face 124, and to each other.

The pivoting frame assembly 150 second cooperating pivot connection includes a pivot tube 156 at a rear end and a front attachment point for the tilt knuckle assembly 210 at the front end and a rear attachment point at the rear end for the actuator 202. A lower portion of the pivoting frame assembly 150 is formed by an upper pivot plate 152 opposite a lower pivot plate 154, with the pivot tube 156 extending through the rear portions of the plates 152, 154. The plates 152, 154 have a wide rectangular front portion, and extend rearward to a narrow portion at the pivot tube 156 forming a generally triangular rear portion. Extending between the upper and lower pivot plates 152, 154 are gussets. A front frame gusset 157 at the front end extends between a first end at the left side and a second end at the right side. A first frame gusset at the left side extends rearward from the front frame gusset 157 toward the pivot tube 156, and a second frame gusset 160 at the right side extends rearward from the front frame gusset 157 toward the pivot tube 156, with the plates 152, 154, and gussets forming a box-like-structure having a rectangular front portion and a triangular rear portion, providing structural rigidity to the lower portion of the pivoting frame assembly 150. The triangular rear portion allows the pivoting frame assembly 150 to pivot about the pivot pin 148 between the front edges of the first and second side plates 140, 144. The above components of the pivoting frame assembly 150 are manufactured from metal and may be welded to each other.

A spring on each side of the pivot assembly 130 are connected to the side of the pivoting frame assembly 150 for centering the blade 328 relative to the skid steer loader 102 when the blade 328 is not in the ground, and aiding the skid steer loader 102 operator in properly aligning the blade 328 during use, such as when forming curved trenches 112, and such as addressing alignment issues due to side to side movement of the blade 328 from the vibrations of the drop plow system 100 or movement of the blade 328 due to ground 116 conditions. A first end of pivot spring 192 is connected to the first end of the front frame gusset 157 by a pivot anchor 194 and a second end of the pivot spring 192 is connected to the first side plate 140 by the mount 142. A first end of pivot spring 198 is connected to the second end of the front frame gusset 157 by a pivot anchor 200 and a second end of the pivot spring 198 is connected to the second side plate 144 by the mount 146. In an implementation, the pivot anchors 194, 200 may be threaded rods allowing for an adjustment to the length of the springs and therefore the tension of the springs. Additionally, the pivoting of the pivot assembly 130 is permitted and limited by the pivot springs 192, 198.

The upper portion of the pivoting frame assembly 150 is formed by adjacent first and second side plates 162, 174 providing the attachment points for the tilt knuckle assembly 210 and an actuator 202. The first side plate 162 is at the left side attached to the upper pivot plate 152. The first side plate 162 extends from a toe 164 extending over the front edge of the upper pivot plate 152 to the front frame gusset 157, rearward to a heel 168 adjacent the pivot tube 156. The second side plate 174 extends from a toe 176 extending over the front edge of the upper pivot plate 152 to the front frame gusset 157, rearward toward to a heel 180 adjacent the pivot tube 156. The toes 164, 176 extend over the front of the lower portion, and the heels 168, 180 extend inward toward the pivot tube 156 adding structural rigidity to the side plates 162, 174. The rear ends of the first and second side plates 162, 174 form rear apertures forming the rear attachment point for receiving a nut and bolt combination pivotally receiving an end of the actuator 202. A front tube 184 extends between apertures in the forward ends of the first and second side plates 162, 174 forming the front attachment point for receiving a nut and bolt combination for pivotally receiving a first end 207 of the tilt knuckle assembly 210 thereby providing a connection to the frame assembly 150. The above components of the pivot frame assembly 150 are manufactured from metal and may be welded to each other.

The tilt knuckle assembly 210 formed from metal allows the shaker assembly 310 to be positioned down to insert the blade 328 into the ground (as shown in FIG. 2) into a trench forming position, and up to remove the blade 328 from the ground (as shown in FIG. 3) into a transport position. The tilt knuckle assembly 210 is generally Y-shaped, with the base of the Y-shape extending from the first end 207 to a lower branch or arm at a second end 208, and from the base to an upper branch or arm at a third end 209. In an implementation, the tilt knuckle assembly 210 is formed from parallel, spaced first and second side plates 212, 240. The first side plate 212 extends from a first end 214 forming a first aperture to a lower arm at a second end 220 forming a second aperture, and to a third upper arm at a third end 226 forming third and fourth apertures, with the third aperture located between the fourth aperture and the first end 214. The second side plate 240 extends from a first end 242 forming a first aperture to a lower arm at a second end 246 forming a second aperture, and to a third upper arm at a third end 250 forming third and fourth apertures with the third aperture located between the fourth aperture and the first end 214. A first gusset 236 extends between the side plates 212, 240 and the first apertures and third apertures, and a second gusset 238 extends between the side plates 212, 240 and the second apertures and the first gusset 236, with the gussets adding structural support to the tilt knuckle assembly 210. The side plates 212, 240 are adapted to pivotally mount the first end 207 to the forward ends of the first and second side plates 162, 174 of the pivoting frame assembly 150.

An actuator 202 extends from a first end 204 pivotally connected to the pivoting frame assembly 150 and a second end 206 pivotally connected to the tilt knuckle assembly 210. In an implementation, the first end 204 is connected to the side plates 162, 174 between the side plates by securing a nut and bolt combination through the side plates, and the second end 206 is connected between the first side plate 212 and second side plate 240 by securing a nut and bolt combination through the second end 206 and the third apertures in the side plates. Actuating the actuator 202, such as a hydraulic actuator or electro-mechanical actuator, raises and lowers the blade 328, enhancing the ability of the skid-steer loader 102 operator to maneuver the drop plow system 100 during use. Retraction of the actuator 202 rod or shaft moves the blade 328 upward, and extension of the rod or shaft moves the blade 328 downward.

The upper branch and lower branch of the tilt knuckle assembly 210 provide attachment points for the shaker assembly 310. The shaker assembly 310 has a metal housing 312 connected to the tilt knuckle assembly 210 by upper and lower metal dampening arms 256, 288. The upper dampening arm 256 extends from a first end 258 pivotally connected to a pivot point at the third end 209 of the tilt knuckle assembly 210 to a second end 286 pivotally connected to an upper pivot point of the housing 312. The lower dampening arm 288 extends from a first end 290 pivotally connected to a first pivot point 291 at the second end 208 of the tilt knuckle assembly 210 by a nut and bolt combination, to a second end 306 pivotally connected to a lower pivot point of the housing 312 between the side plates 314, 318 at a second pivot point 307 by the lower apertures. The pivoting connections can be made by pins or nut and bolt combinations passing through apertues in the housing 312 and arms 256, 288.

The upper dampening arm 256 first end 258 is pivotally connected to the third end 209 at a first pivot point 259 by a nut and bolt combination. The housing 312 includes a first side plate 314 at the left side forming an upper portion with an upper aperture and a lower portion with a lower aperture, and a second side plate 318 at the right side forming an upper portion with an upper aperture and a lower portion with a lower aperture. Between the first end 258 and second end 286 is a second pivot point 273 pivotally attaching the upper dampening arm 256 to the upper apertures, between the side plates 314, 318 by a pin or nut and bolt combination. Forward of the second pivot point 273 is a vibration dampening material to absorb vibration from the shaker assembly 310 during use and minimize transfer of the vibration to the skid steer loader 102 and the support and articulation assembly. In an implementation, the dampening material is silicone or rubber and provides the connection between the second end 286 and the shaker assembly 310. A first dampening puck 274 is disposed between the first side plate 314 and the upper dampening arm 256, and a second dampening puck 276 is disposed between the second side plate 318 and the upper dampening arm 256. An additional dampening puck may be included adjacent the first and second dampening pucks 274, 276. A lower dampening puck 282 is disposed between the second end 286 and the top of the housing 312 of the shaker assembly 310. In an implementation, the shaker assembly 310 further includes a damper top plate 340 connected to the shaker assembly 310 and positioned above the upper dampening arm 256, with an upper dampening puck 278 between the upper dampening arm 256 and the damper top plate 340. The damper top plate 340 may be supported by a first damper side plate 342 at the left side connected to the damper top plate 340 and first side plate 314, and a second damper side plate 344 at the right side connected to the damper top plate 340 and second side plate 318. The dampening pucks are secured to the upper dampening arm 256 and adjacent structure such as by a bolt.

In an implementation, the upper dampening arm 256 is composed of a first side plate 260 and an adjacent second side plate 266, with a gusset 272 extending between the side plates adding rigidity to the arm, an upper plate connecting the side plates to the upper dampening puck 278, and a lower plate connecting the side plates to the lower dampening puck 282. Further, the lower dampening arm 288 may be composed of a first side plate 292 and an adjacent second side plate 298, with a gusset 304 extending between the side plates adding rigidity to the arm. The above components of the dampening arms are manufactured from metal and may be welded to each other.

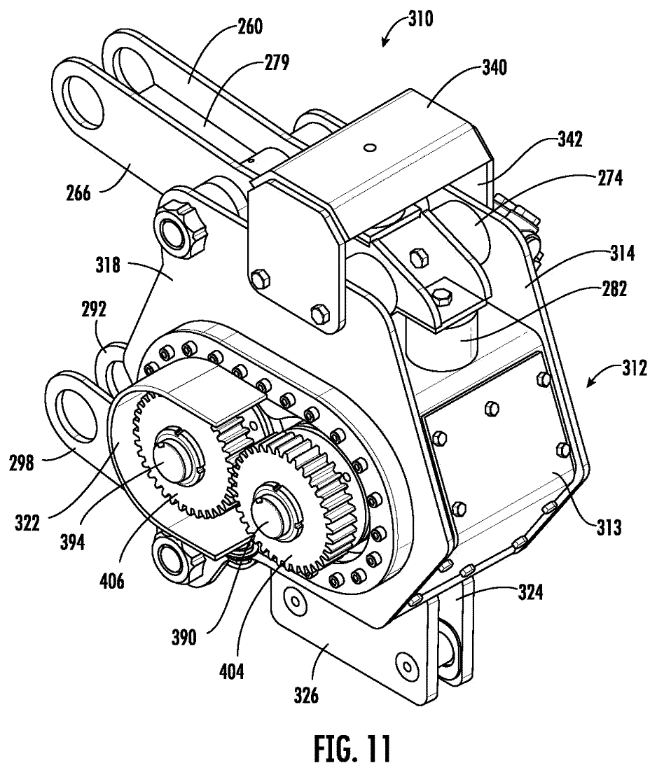

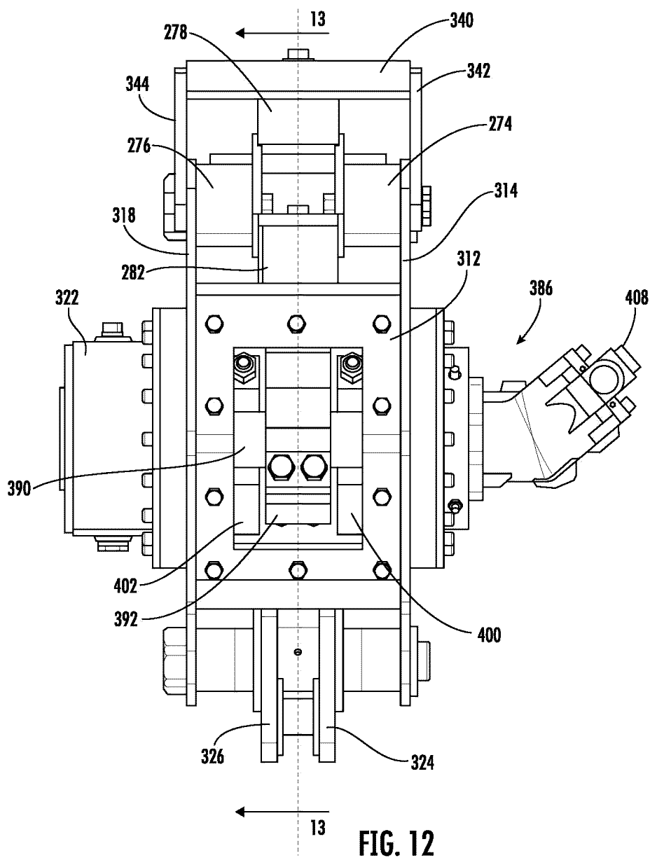

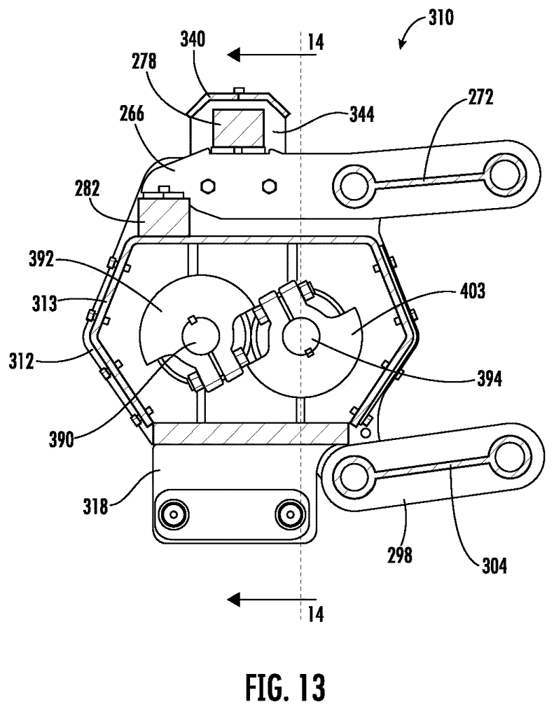

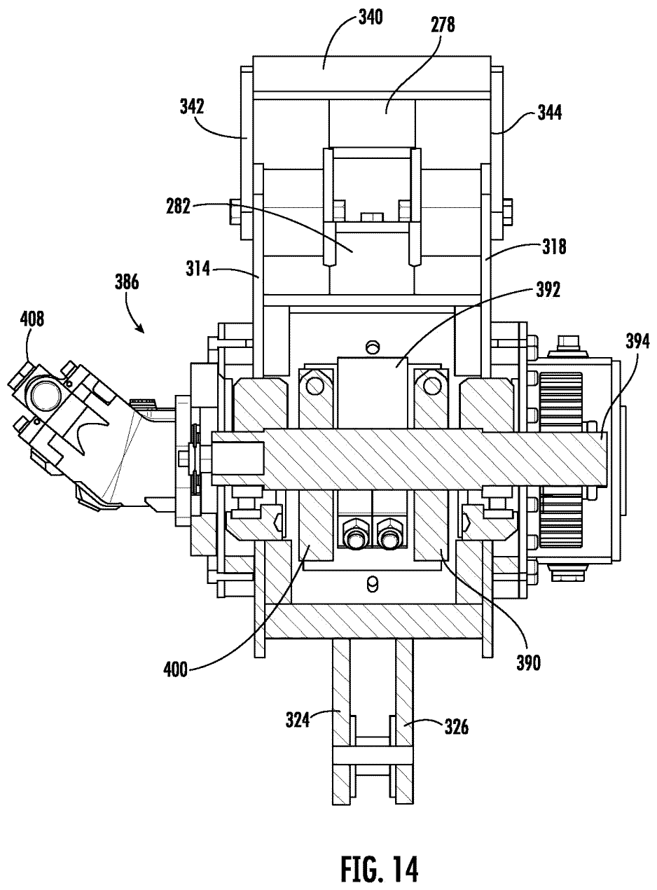

Referring to FIGS. 11-14, the shaker assembly 310 is formed from metal includes a shaker weight assembly 386 with at least one weight attached to a rotatable shaft within the housing 312 driven by a power source, with the blade 328 being operably attached to the housing 312. The housing 312 may include a front cover 313. In an implementation, the shaker weight assembly 386 includes adjacent first and second shafts 390, 394, mounted on bearings on each end, with the second shaft 394 having a centrally located first weight 392 with a mass adjacent the first shaft 390, and with the second shaft 394 extending from a first end 396 to a second end 398 with a second weight 400 adjacent the first end 396 with a mass adjacent the second shaft 394 and a third weight 402 adjacent the second end 398 with a mass adjacent the second shaft 394. Adjacent ends of the shafts 390, 394 include cooperating gears 404, 406 within a gear housing 322 permitting the power source operably connected to one of the shafts to rotate both of the shafts. In an implementation, the power source is connected to the second shaft 394. The power source can assume a variety of configurations, and can be powered in a variety of ways, such as electrically and hydraulically. In an implementation, the power source is a hydraulic motor 408 driven by the hydraulic system 372. The shafts 390, 394 are spaced apart permitting the weight masses to move within the housing 312 in a manner whereby the weights do not hit each other, or the adjacent shafts. In an embodiment, the rotational path of the first weight 392 is between the rotational path of the second and third weights 400, 402. The weights are positioned on each shaft to result in an imbalance during rotation that results in forces that move the shaker assembly forward and rearward, and upward and downward, inducing movement analogous to a shaking motion or a vibration. This movement is transmitted to the blade 328.

In an implementation, the blade 328 is detachable from the base housing 312. The base may include adjacent first and second blade mounting plates 324, 326 for attaching a proximal end 330 of the blade 328 with fasteners 331, such as a nut and bolt combination, by passing the fasteners 331 through apertures in the plates 324, 326 and blade 328. The detachability facilitates replacement of a worn or damaged blade 328, or if there is a desire to use a blade 328 with different structural characteristics.

The blade 328 is formed from metal and extends from the proximal end 330 to a distal end 332 forming a rearward-facing tip 334. A person of skill in the art will appreciate the selection of the material (hardened steel, etc.) of the blade 328 and tip 334, and shape of the tip 334, is influenced by the condition of the soil the blade 328 is used with. The leading edge 333 of the blade 328 may be flat, angular, or convex depending on the condition of the soil, allowing the blade 328 to cleave and plow through the ground 116 and subsoil. The trailing edge 337 of the blade 328 may include an extension 338 for attachment of an object, such as a chain or cable, for attachment to material, such as conduit or cabling, to pull such material through the trench 112 created by the blade 328. In an implementation, the extension 338 is one plate or two plates welded to the blade 328 with an aperture for attaching a chain or cable. A wedge 336 structure located rearward of the extension 338 aids in creating an opening in the ground wider than the width of the blade 328 to facilitate placing material in the ground. In an implementation, the wedge 336 structure is formed by a triangular-shaped wedge structure extending from a narrow tip rearward toward the trialing edge 337 forming a wide base. In an implementation, the wedge 336 is formed by upper and lower triangular shaped surfaces. The upper triangular shaped surface extends from a narrow tip at the rear forward to a wide base portion, with an upper edge extending upward and forward along the body of the blade 328, and a lower edge extending outward from the body of the blade 328. The lower triangular shaped surface extends from a narrow tip at the rear forward to a wide base portion, with an upper edge extending outward from the body of the blade 328 in conjunction with the upper triangular shaped surface lower edge, and a lower edge extending downward and forward along the body of the blade 328.

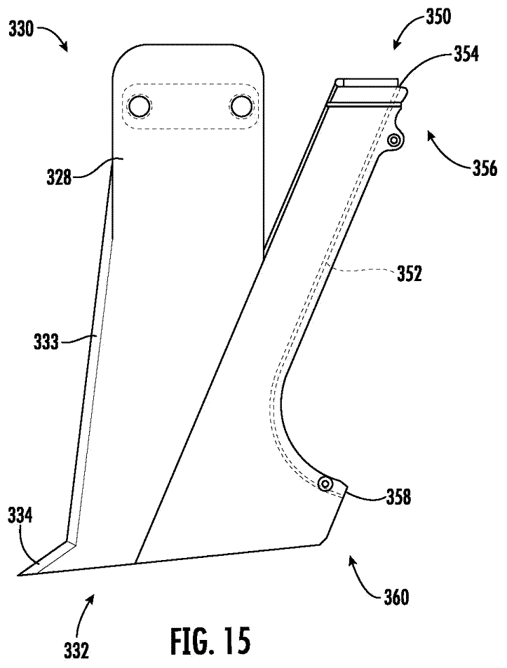

Referring to FIG. 15, in an implementation, the blade 328 may include a passage permitting the laying or burying of material within the trench 112 when plowing. In an implementation, a chute blade 350 manufactured from metal attachable to the blade 328 by welding or by fasteners, incudes a passage 352 extending from an opening 354 at a first end 356 to a trailing edge opening 358 at a second end 360. The passage 352 may transition from a generally straight orientation at the first end 356 to a generally horizontal orientation at the second end 360 at the trailing edge opening 358. As the skid steer loader 102 moves in a rearward direction 110 the material, such as conduit or cabling, enters the opening 354 generally above the ground 116 in a generally vertical orientation, and exits the passage 352 at the trailing edge opening 358 at a generally horizontal orientation below the surface 114, burying the material within the trench 112.

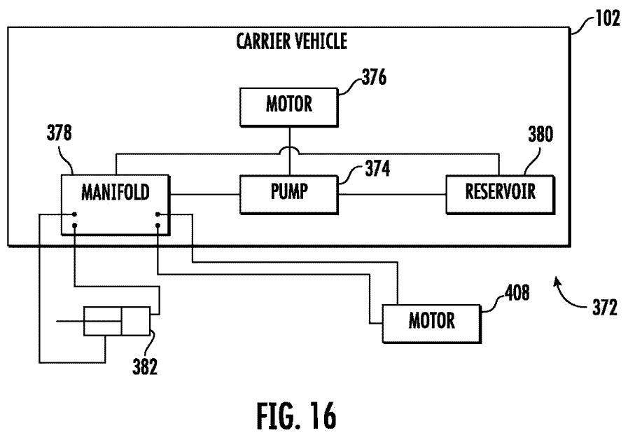

In an implementation the actuator 202 is a hydraulic lift cylinder 382 connected to a hydraulic system 372. The hydraulic system 372 can be independent of the skid-steer loader 102, or it can be part of the skid-steer loader 102. Referring to FIG. 16, an exemplary hydraulic system 372 with a hydraulic pump 374 is powered by the skid-steer loader 102 motor 376 for use with the drop plow system 100. In an implementation, the hydraulic lift cylinder 382 is fluidly connected to the hydraulic system of the skid-steer loader 102. The hydraulic lift cylinder 382 is connected by hydraulic hoses to a hydraulic valve assembly of a manifold 378 and a hydraulic reservoir 380. The power source is operably connected to the manifold 378 and reservoir 380 by hoses. The pump 374 is connected to a manifold 378 for providing hydraulic fluid to the hydraulic lift cylinder 382 and power source. The hydraulic system 372 is operated in a conventional manner.

In use, an operator of the skid steer loader 102 connects to the attachment mechanism 120, and makes the necessary electrical and hydraulic power connections to the actuator 202 and power source. The drop plow system 100 positions the pivoting frame assembly 150, tilt knuckle assembly 210, and shaker assembly 310 a distance from the cab 104 permitting an operator to open the cab 104 door 106 when the blade 328 is in the transport position (FIG. 3) or when the blade is in the trench forming position (FIG. 2). The operator moves the skid steer loader 102 and drop plow system 100 to a location to start insertion of the desired material or the desired trench 112 begin position into the ground 116. An operator lowers the blade 328 by extending the actuator 202 to engage the blade 328 with the ground 116, and engages the power source causing the shafts 390, 394 of the shaker weight assembly 386 to rotate, inducing vibration into the blade 328 reducing resistance to the blade 328 moving through the ground 116. The operator moves the skid steer loader 102 in the rearward direction 110 causing the blade 328 to move in the rearward direction 110 creating the trench 112 within the ground 116. The operator can adjust the depth of the blade 328 within the ground 116 by actuating the actuator 202 to form the base 113 of the trench 112 at the desired depth, and place any material exiting the trailing edge opening 358 at the desired depth. The operator can turn the skid steer loader 102 and the pivoting frame assembly 150 pivots about the pivot pin 148, allowing the blade 328 to form a curved portion of the trench 112. When the operator reaches the location to cease creating a trench 112, the actuator 202 is retracted to disengage the blade 328 from the ground 116, and the power source 288 is disengaged, ceasing vibration of the shaker assembly 310 and blade 328. Material, such as cabling or conduit may be fed into the opening 354 of the passage 352 formed by either the blade 328 or a chute blade 350 attached to the blade 328 at the beginning of the trenching process, with the material exiting the passage 352 at the end of the trenching process. When the drop plow system 100 is not in use, the operator can lower the system 100 to the ground, placing the bottom of the attachment mechanism 120 and the bottom of the blade 328 in contact with the ground, allow the system 100 to be stored upright or when in transit on a trailer, without the need for additional support when detached from the skid steer loader 102.

It is understood that the present subject matter may be embodied in many different forms and should not be construed as being limited to the embodiments set forth herein. Rather, these embodiments are provided so that this subject matter will be thorough and complete and will convey the disclosure to those skilled in the art. Indeed, the subject matter is intended to cover alternatives, modifications, and equivalents of these embodiments, which are included within the scope and spirit of the subject matter as defined by the appended claims and their equivalents. Furthermore, in the detailed description of the present subject matter, numerous specific details are set forth in order to provide a thorough understanding of the present subject matter. However, it will be clear to those of ordinary skill in the art that the present subject matter may be practiced without such specific details.

1. A soil-shifting device for attachment to a vehicle, the device comprising:
a pivot assembly for connecting the device to a vehicle;
a pivoting frame assembly having a rear end and a front end, wherein the rear end of the pivoting frame assembly is pivotally connected to the pivot assembly;
a plow blade for forming a trench in soil; and
a tilt knuckle assembly, wherein the tilt knuckle assembly is pivotally connected to the front end of the pivoting frame assembly and is operably connected to the plow blade for pivoting the plow blade forward and rearward relative to the pivoting frame assembly.

2. The device of claim 1, comprising:
wherein the pivot assembly, comprises:
a mounting plate having a front face and a rear face;
wherein the rear face forms a vehicle engaging surface; and
wherein the front face forms a pivot connection with the pivoting frame assembly.

3. The device of claim 1, comprising:
wherein the pivoting frame assembly front end forms a wide front portion; and
wherein the pivoting frame assembly rear end forms a narrow rear portion.

4. The device of claim 3, comprising:
wherein the pivoting frame assembly forms a front attachment point and a rear attachment point;
wherein the front attachment point is adapted to receive the tilt knuckle assembly; and
wherein the rear attachment point is adapted to receive an end of an actuator operably connected to the tilt knuckle assembly.

5. The device of claim 4, comprising:
wherein the pivot assembly has a first side and a second side;
wherein the pivoting frame assembly has a first side and a second side;
a first spring connected to the pivot assembly first side and the pivoting frame assembly first side;
a second spring connected to the pivot assembly second side and the pivoting frame assembly second side; and
wherein the springs center the pivoting frame assembly relative to the pivot assembly.

6. The device of claim 1, comprising:
a shaker assembly attached to the tilt knuckle assembly; and
wherein the plow blade is attached to the shaker assembly.

7. The device of claim 6, comprising:
wherein the tilt knuckle assembly comprises:
a first end pivotally connected to the pivoting frame assembly front end;
a lower arm defined as extending from the first end to a second end; and
an upper arm defined as extending from the first end to a third end;
wherein the shaker assembly comprises:
a housing with an upper pivot point and a lower pivot point;
an upper dampening arm extending from a first end to a second end, wherein the first end is pivotally connected to the tilt knuckle assembly third end, and wherein the upper dampening arm is pivotally connected to the upper pivot point between the first end and second end; and
a lower dampening arm extending from a first end to a second end, wherein the first end is pivotally connected to the tilt knuckle assembly second end, and wherein the second end is pivotally connected to the lower pivot point.

8. The device of claim 7, comprising:
wherein the shaker assembly further comprises:
a first rotatable shaft within the housing;
a second rotatable shaft within the housing adjacent the first rotatable shaft;
a first weight attached to the first rotatable shaft;
a second and third weight attached to the second rotatable shaft; and
wherein rotation of the shafts generates a shaking motion.

9. A soil-shifting device for attachment to a vehicle, the device comprising:
a pivot assembly, comprising:
a vehicle engaging portion; and
a first pivot connection;
a pivoting frame assembly, comprising:
a front end and a rear end; and
a second pivot connection at the rear end adapted to interface with the first pivot connection, whereby the pivoting frame assembly rotates about the first pivot connection;
a tilt knuckle assembly pivotally connected to the pivoting frame assembly front end;
a plow blade operably connected to the tilt knuckle assembly; and
an actuator extending from a first end to a second end, wherein the first end is pivotally connected to the pivoting frame assembly, and the second end is pivotally connected to the tilt knuckle assembly for pivoting the tilt knuckle assembly forward and rearward relative to the pivoting frame assembly.

10. The device of claim 9, comprising:
wherein the mounting plate is adapted to engage a coupler attached to a vehicle.

11. The device of claim 9, comprising:
wherein the actuator is pivotally connected adjacent the rear end of the pivoting frame assembly; and
wherein the tilt knuckle assembly is pivotally connected adjacent the front end of the pivoting frame assembly.

12. The device of claim 9, comprising:
a shaker assembly attached to the tilt knuckle assembly; and
wherein the blade is attached to the shaker assembly for forming a trench in the soil.

13. The device of claim 12, comprising:
wherein the shaker assembly includes a housing;
a first rotatable shaft within the housing;
a second rotatable shaft within the housing adjacent the first rotatable shaft;
a first weight attached to the first rotatable shaft;
a second and third weight attached to the second rotatable shaft; and
wherein rotation of the shafts generates a shaking motion.

14. A soil-shifting device for attachment to a vehicle, the device comprising:
a pivot assembly, comprising:
a mounting plate adapted for engaging a vehicle;
a first pivot connection formed by the mounting plate, comprising:
an upper sleeve;
a lower sleeve;
wherein the upper and lower sleeves are aligned along a pivot centerline;
a pivoting frame assembly, comprising:
a front end and a rear end;
a second pivot connection at the rear end, wherein the second pivot connection forms a tube adapted to be disposed between the upper sleeve and lower sleeve and pivotally connected thereto by a pivot pin, and wherein the pivoting frame assembly rotates about the pivot pin;
a rear attachment point;
a front attachment point;
a generally Y-shaped tilt knuckle assembly extending from a first end to a second end defining a lower arm, and extending from the first end to a third end defining an upper arm;
wherein the first end is pivotally connected to the pivoting frame assembly front attachment point;
a shaker assembly operably connected to the tilt knuckle assembly lower arm and upper arm for inducing a shaking movement; and
an elongated blade depending from the shaker assembly for forming a trench in soil.

15. The device of claim 14, comprising:
wherein the pivot assembly further comprises:
an upper pivot plate extending from the mounting plate to the upper sleeve; and
a lower pivot plate extending from the mounting plate to the lower sleeve.

16. The device of claim 14, comprising:
wherein the shaker assembly includes a housing;
a first rotatable shaft within the housing;
a second rotatable shaft within the housing adjacent the first rotatable shaft;
a first weight attached to the first rotatable shaft;
a second and third weight attached to the second rotatable shaft; and
wherein rotation of the shafts generates a shaking motion.
